(19) United States
(12) Patent Application Publication
(10) Pub. No.: US 2025/0219176 A1
(43) Pub. Date: Jul. 3, 2025

(54) PITCH COATING FOR LI-ION BATTERIES

(71) Applicant: Ascend Elements, Inc., Westborough, MA (US)

(72) Inventor: Yilun Tang, Westborough, MA (US)

(21) Appl. No.: 18/400,358

(22) Filed: Dec. 29, 2023

(51) Int. Cl. H01M 10/54; C01B 32/205; C01B 32/215; C22B 7/00

(52) U.S. Cl. CPC H01M 10/54; C01B 32/205; C01B 32/215; C22B 7/006; C01P 2004/61; C01P 2004/84; C01P 2006/12; C01P 2006/40

(57) ABSTRACT

A recycling and enhancement process for graphite from a Li-ion recycling stream includes pitch coating for enhancing tap density and BET surface area compared to virgin materials and commercial graphite, and provide similar, if not greater performance. A multi-step pitch coating process includes two or more pitch coating stages at different temperatures. A first pitch mixing and coating at a lower temperature is followed by a second pitch mixing and coating at a higher temperature, which results in a pitch coated purified graphite having improved surface characteristics over recycled graphite and comparable or better properties compared to virgin (non-recycled) graphite.

### BACKGROUND

Lithium-ion (Li-ion) batteries are a preferred chemistry for secondary (rechargeable) batteries in high discharge applications such as electrical vehicles (EVs) and power tools where electric motors are called upon for rapid acceleration. Li-ion batteries include a charge material, conductive powder, and binder applied to, or deposited on, a current collector, typically a planar sheet of copper or aluminum. The charge material includes anode material, typically graphite or carbon, and cathode material, which includes a predetermined ratio of metals such as lithium, nickel, manganese, cobalt, aluminum, iron and phosphorous, defining a so-called “battery chemistry” of the Li-ion cells. The preferred battery chemistry varies between vendors and applications, and recycling efforts of Li-ion batteries typically adhere to a prescribed molar ratio of the battery chemistry in recycled charge material products. A purity of the constituent products is highly relevant to the quality and performance of the recycled cells, often relying on so-called “battery grade” materials, implying at least a 99.5% purity.

While cathode material recovery is a primary focus of Li-ion battery recycling, a waste stream for recycled batteries generally involves indiscriminate agitation (crushing and shredding) of full battery assemblies, resulting in comingled mixtures of cathode, anode, separator and casing materials. Recycling procedures directed towards cathode material recovery often result in a substantial volume of unused and/or discarded anode materials.

### SUMMARY

In a recycling and enhancement process for Li-ion batteries, a pitch coating is applied to anode material from a Li-ion recycling stream for enhancing physical properties, such as tap density, BET (Brunauer-Emmett-Teller), particle size distribution, and surface area, as well as electrochemical performance of a recycled anode material. A multi-stage pitch coating process is used that includes two or more pitch coating processes at specified temperatures. For example, using a purified graphite from a recycling stream, a first pitch mixing and coating at a lower temperature is followed by a second pitch mixing and coating at a higher temperature. The resulting pitch-coated purified graphite has been found to have improved surface characteristics over the recycled graphite, and comparable or better properties than virgin (non-recycled) graphite.

Configurations herein are based, in part, on the observation that the recycling of anode materials from spent or waste Li-ion batteries is becoming more feasible as the demand for Li-ion batteries increases. Unfortunately, conventional recycling efforts suffer from the shortcoming that they are not focused on anode material recovery. Rather, cathode materials have traditionally been sought for recycling, particularly for the more expensive cobalt and nickel battery grade metal material. Anode materials remaining after cathode recycling are not of sufficient physical characteristics, such as BET surface area and tap density, or purity to be considered “battery grade”.

Configurations herein, however, substantially overcome the shortcomings of conventional recycling methods by providing an anode recycling process sourced from an output of a cathode recycling process, particularly having an Ni, Mn, Co (NMC) or similar battery chemistry. For example, a graphite-rich remainder of an NMC leach process is separated from the constituent NMC and lithium materials, and a multistage pitch coating treatment with intermediate heating phases is used to generate high quality graphite for anode material having favorable purity, BET, and tap density characteristics.

In a particular configuration, a method of producing a pitch coated purified graphite is described that comprises combining 1) a purified graphite from a recycled battery stream and 2) pitch to thereby form a graphite mixture. The graphite mixture is then heated to a first maximum temperature to form a coated graphite. Additional pitch and the coated graphite are combined to form a coated graphite mixture, which is heated to a second maximum temperature to form the pitch coated purified graphite. In a specific configuration, the purified graphite is prepared by a method comprising leaching a black mass of exhausted lithium-ion batteries from the recycled battery stream to obtain a leach solution and a precipitate comprising graphite.

The resulting precipitate is then purified using a process capable of removing impurities from the graphite, such as water insoluble metal impurities. For example, the recycled graphite precipitate can be treated with an aqueous solution of a strong base such as NaOH to convert the water insoluble metal impurities to water-soluble metal hydroxides. In a preferred configuration, purification is achieved by an iterative roasting process followed by a washing process to remove the formed water-soluble hydroxides. An optional acid washing process can also be used to produce a further purified recycled graphite.

For example, the precipitate is sintered by preparing a slurry of the precipitate with a first aqueous solution of a hydroxide base. The concentration of the hydroxide is preferably ≤40% by weight, and the slurry of the precipitate is roasted at a temperature that is preferably <250° C. to form a sintered precipitate. The sintered precipitate is then sintered by preparing a slurry of the sintered precipitate with a second aqueous solution of a hydroxide base, such as a solution having a concentration of hydroxide of ≤40% by weight. The slurry of the sintered precipitate is roasted, such as at a temperature of <250° C. to form a sintered graphite. The sintered graphite is then washed to form the purified graphite.

### BRIEF DESCRIPTION OF THE DRAWINGS

The foregoing and other features will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles of the invention.

FIG. 1 is a context diagram of a recycling environment suitable for use with configurations herein;

FIG. 2 is a flowchart of pitch coating graphite from recycled batteries as in the environment of FIG. 1;

FIG. 3 shows BET and tap density for different pitch concentrations using the approach of FIG. 2;

FIG. 4 shows a graph of BET and tap density as in FIG. 3;

FIG. 5 shows the recycled, pitch coated material vs. virgin/control/sourced graphite, and

FIGS. 6A-6B show respective graphs of virgin and recycled graphite for specific capacity and ICE %.

### DETAILED DESCRIPTION

Depicted below is an example method and approach for recycling anode material from batteries such as NMC batteries. Configurations herein preferably employ NMC battery chemistry as an example. However, the disclosed approach may be practiced with any suitable battery chemistry.

Li-ion batteries employ a so-called battery chemistry, which defines the types and ratios of metal ions used to form the cathode material. The particular ratio is set by the manufacturer or recipient of the recycled charge material. However, almost all batteries employ an anode charge material, and the anode material is almost always a carbon or graphite formulation, independent of the cathode material chemistry. The purity and form of the graphite is also set by the manufacturer.

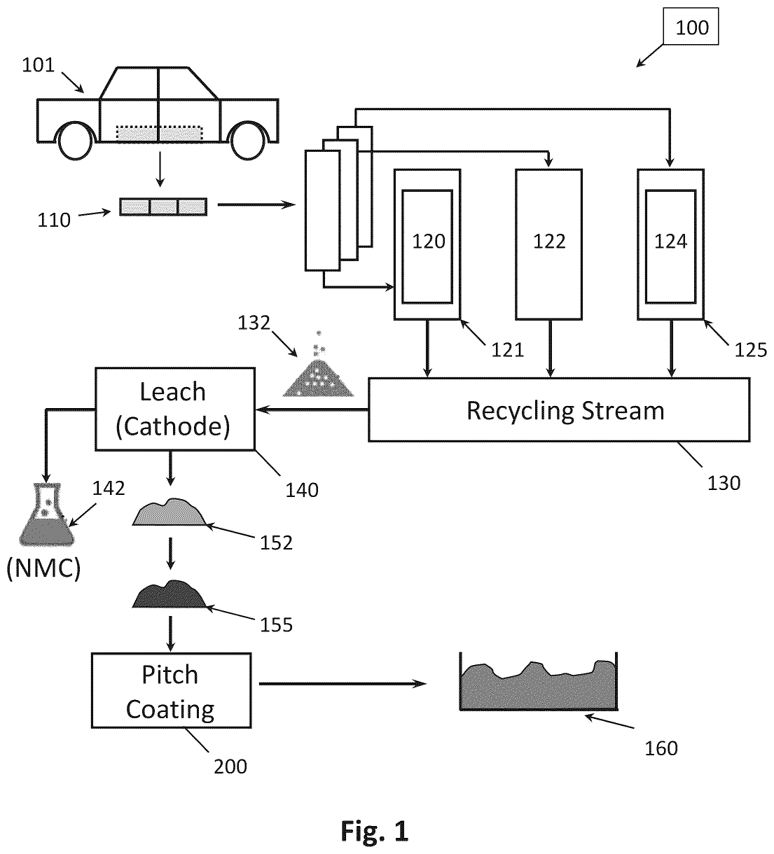

FIG. 1 is a context diagram of a recycling environment suitable for use with configurations herein. Referring to FIG. 1, in battery recycling environment 100, end-of-life Li-ion batteries 110 from EVs (Electric Vehicles) 101 or other sources have valuable raw materials in the form of charge materials. Each battery 110 includes an anode formed from an anode current collector 121 with anode charge material 120 (anode material) deposited or adhered thereto, and a cathode formed from a cathode current collector 125 with cathode charge material 124 (cathode material) deposited or adhered thereto. A separator 122 separates the anode material 120 from the cathode material 124, and the respective current collectors 121, 125 form the positive and negative poles of the battery. The anodes and cathodes are stacked or rolled into cells and packs within an enclosure according to a predetermined structure, often specific to the manufacturer and vehicle model.

Collectively, a plurality of the batteries 110 are used to form a recycling stream 130 producing a comingled granular mass of dismantled battery materials formed by grinding, crushing and pulverizing the packs and cells. The comingled granular material is used to isolate a black mass 132 of cathode and anode material. A cathode recycling process 140 is used to extract cathode charge material metals as a leach solution 142, typically comprising nickel, manganese, cobalt and lithium from the black mass. The remaining solids following the leach can be separated to form recycled anode material 152 rich in graphite and is received into an anode recycling process in which recycled graphite is converted into battery grade purified graphite 155. The anode recycling process may include graphite recovery and purification such as that disclosed in U.S. patent application Ser. No. 18/114,488, filed Feb. 27, 2023, entitled “RECYCLED GRAPHITE FOR LI-ION BATTERIES,” incorporated herein by reference in entirety. The resulting purified graphite 155 is then used in a pitch coating process 200 as disclosed herein. The pitch coating process 200 yields a pitch coated battery grade graphite 160, found to have enhanced performance characteristics and improved physical properties. Specifically, in the pitch coating process, the purified graphite is treated with a fine powder of carbonaceous material referred to as pitch which coats the surface of purified graphite 155 to generate pitch coated purified graphite 160. Example properties of the purified graphite is shown in Table I below.

TABLE I

| | |
|---|---|
| D10 um | 5.683 |
| D50 um | 12.139 |
| D90 um | 23.881 |
| TD g/ml | 0.811 |
| BET m2/g | 4.6894 |
| Al ppm | 22.9 |
| Purity % | >99.9% |
| Moisture ppm | 146.5 |

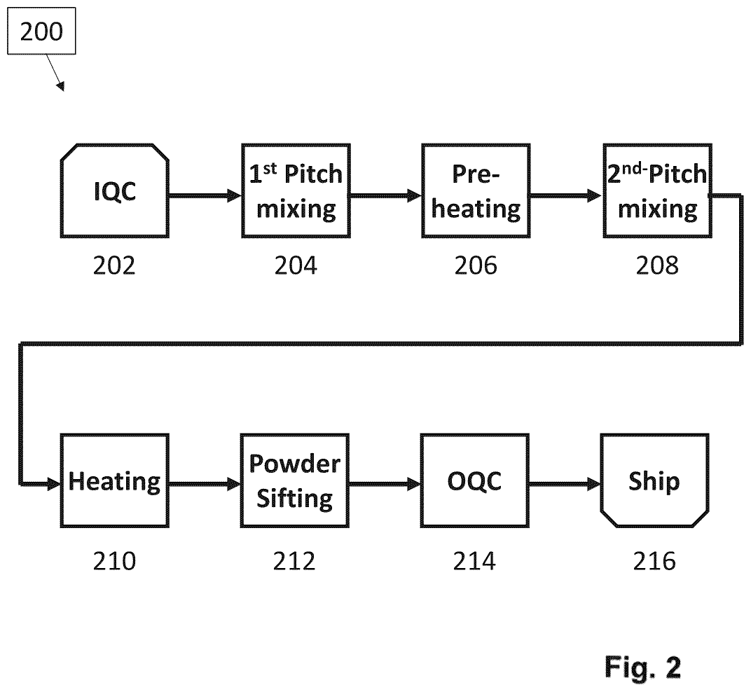

Referring to FIGS. 1 and 2, configurations of the method of pitch coating of the purified graphite 200 includes receiving graphite from a recycled battery stream, preferably purified graphite 155 from the recycling environment in FIG. 1. Continuing from FIG. 1, the graphite source typically undergoes an initial quality control verification, at step 202, which may be optional. A purity of greater than 99.5% is desired for the purified graphite, however a lesser purity can still be accommodated by the pitch coating process.

A quantity of the purified graphite from the recycled battery stream and a quantity of pitch are combined to form a graphite mixture, as shown at step 204. The graphite mixture is heated to a first maximum temperature in a pre-heating phase 206 to form a coated graphite. The temperature is chosen based on the type of pitch (i.e., pitch grade) that is used. For example, the first maximum temperature should be greater than or equal to the softening point of the pitch but below a decomposition temperature of the pitch. As a particular example, the first maximum temperature is about 300° C.-500° C., such as 400° C.

In a second pitch coating process, the coated graphite and additional pitch are combined to form a coated graphite mixture, as depicted at step 208. The additional pitch may be the same or different from the quantity of pitch used in step 204, depending on, for example, desired final properties. Preferably, the same pitch is used as the additional pitch. After the second pitch addition/mixing, the coated graphite mixture is heated to a second maximum temperature. This can vary depending on the grade of pitch used but is typically higher than the first maximum temperature and can be, for example, between 1000° C.-1300° C. to form the pitch coated purified graphite mixture, as shown at step 210. This two-stage heating has been found to have a beneficial effect on the surface characteristics of the graphite particles as the pitch coats the surface, discussed further below. Optional powder sifting may be applied to the resulting pitch coated purified graphite, as depicted at step 212. In this way, particle size may be improved but with some loss. An optional final quality control evaluation 214 precedes shipment and anode electrode manufacturing, at step 216.

Various parameters and enhancements can be used to regulate pitch coating process 200 including, for example, the pitch quantity (ratio of graphite to pitch), the duration and method of the mixing, and the temperature ranges and heating rates of the first (preheating) and second (primary) heating. For example, returning to step 204, the pitch and the purified graphite from the recycling stream can be combined in selected ratios and for a defined mixing duration. In a particular arrangement, the purified graphite and the pitch are combined in a graphite to pitch weight ratio of from 90:10 to 99:1 (i.e., the amount of pitch is from about 1-10% by weight based on the weight of the graphite), including a graphite to pitch weight ratio of from 90:10 to 95:5 (5-10% by weight based on the weight of the graphite). The purified graphite and the pitch may be combined for a total mixing time of 5-60 minutes, such as from 20-40 minutes.

During extended mixing, the friction created can cause the mixture to heat. It may be beneficial to perform two mixing phases with a cool-down interval in between. Accordingly, the purified graphite and the pitch can be combined by mixing for a first mixing time of 5-30 minutes to form an intermediate graphite mixture, which is then allowed to cool, such as to room temperature. The cooled intermediate graphite mixture can then be mixed for a second mixing time of from 5-30 minutes to form the graphite mixture. Specific mixing conditions can be adjusted depending on, for example, the type mixing equipment used, the mixing speed, and the amount of material.

Referring again to step 206, preheating includes moderate heating of the graphite mixture, preferably at a lower temperature than the later heating step 210. In one example, the graphite mixture may be heated to the first maximum temperature at a rate of from 1-5° C./min and held at the first maximum temperature for a duration of from for 0.5-4 hours. Other suitable temperatures and intervals may be performed. One particular use case involves heating to 400° C. at 3° C. per min and maintaining 400° C. for two hours. Other temperature ranges and intervals may be provided in alternate configurations.

The coated graphite that results from the preheating at step 206 undergoes a second pitch mixing 208. Referring again to step 208, the coated graphite and additional pitch may be combined in a graphite to pitch weight ratio of from 90:10 to 99:1, such as a graphite to pitch ratio of from 90:10 to 95:5. The coated graphite and the additional pitch may be combined for a total mixing time of 5-60 minutes, including for a total mixing time of 20-40 minutes. A cool-down interval may also intervene between two mixing intervals. Specifically, the coated graphite mixing may include a first mixing time of from 5-30 minutes to form an intermediate coated graphite mixture, allowing the intermediate coated graphite mixture to cool, and then mixing the cooled intermediate coated graphite mixture for a second mixing time of from 5-30 minutes to form the coated graphite mixture.

The second mixing step is followed by a second heating step. Referring again to step 210, the coated graphite mixture can be heated to a second maximum temperature of between 1000° C.-1300° C., such as about 1200° C. In general, the second maximum temperature is greater than the first maximum temperature. The heating duration of the second maximum temperature may be staged over a heating time of from 10-40 hours.

An example profile for heating at the second maximum temperature is:
raise temperature to 150° C. over 5 hrs, then hold for 2 hrs.
150-300° C. over 5 hrs, then hold for 2 hrs.
350-600° C. over 5 hrs, then hold for 2 hrs.
600-900° C. over 5 hrs, then hold for 2 hrs.
900-1150° C. over 5 hrs, then hold for 2 hrs
   An inert gas such as N₂ may be provided during the second heating step 210.

The powder sifting step 212 may employ a plurality of sifting grades. In one example, 60 mesh sieving is employed for between 2-4 minutes, followed by a 400 mesh sieving for another 2-4 minutes. Other suitable sieving sizes and durations may be employed. A modest step loss of the pitch coated purified graphite may occur, such as between 10%-20% including about 15.9%.

The anode recycling stream 152 which forms the purified graphite 155 complements a full battery recycling stream of anode and cathode material. Returning to FIG. 1, the purified graphite 155 may result from a recycling process including leaching a black mass 132 of exhausted lithium-ion batteries from the recycled battery stream to obtain a leach solution and a precipitate comprising graphite. The precipitate can then be sintered by preparing a slurry of the precipitate with a first aqueous solution of a hydroxide base having a concentration of hydroxide of ≤40% by weight and roasting the slurry of the precipitate at a temperature of <250° C. to form the sintered precipitate. The sintered precipitate can then be sintered by preparing a slurry of the sintered precipitate with a second aqueous solution of a hydroxide base having a concentration of hydroxide of ≤40% by weight and roasting the slurry of the sintered precipitate at a temperature of <250° C. to form a sintered graphite. The sintered graphite may then be washed to form the purified graphite 155. In particular, the sintered graphite may be washed with an aqueous wash solution to a pH of from 6 to 10.

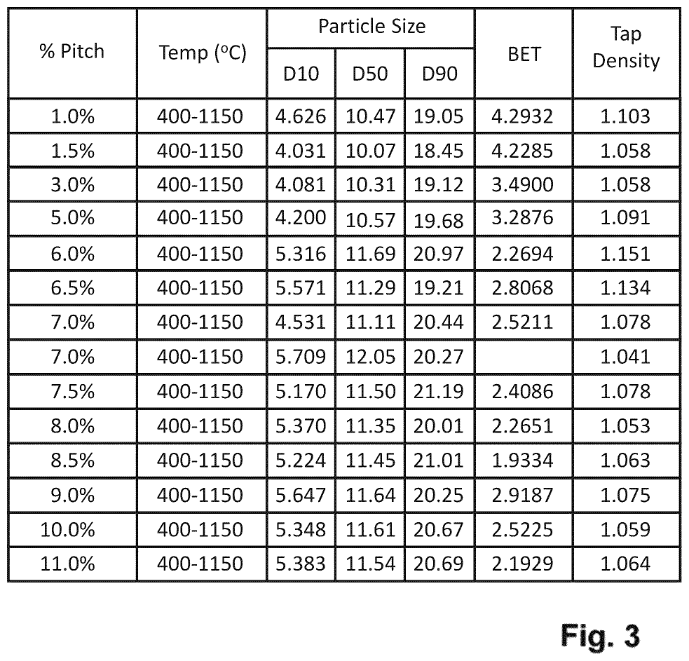

Surprisingly, it has been found that the use of at least two pitch coating steps, preferably at different coating temperatures, results in a pitch coated purified graphite having beneficial characteristics, including enhanced tap density and BET, which do not result from a single coating process. FIG. 3 shows BET and tap density for different pitch concentrations using the approach of FIG. 2. Referring to FIGS. 1-3, morphology and particle characteristics for a series of pitch percentages are shown. It was found that trials using 6-6.5% and 7.5-8.5% (by weight) of pitch to graphite provide a good balance of properties, while trials using 7.0-7.5 wt % pitch generate optimal BET and tap density values, particularly using 400° C. for preheating 206 and 1150° C. for primary heating 210.

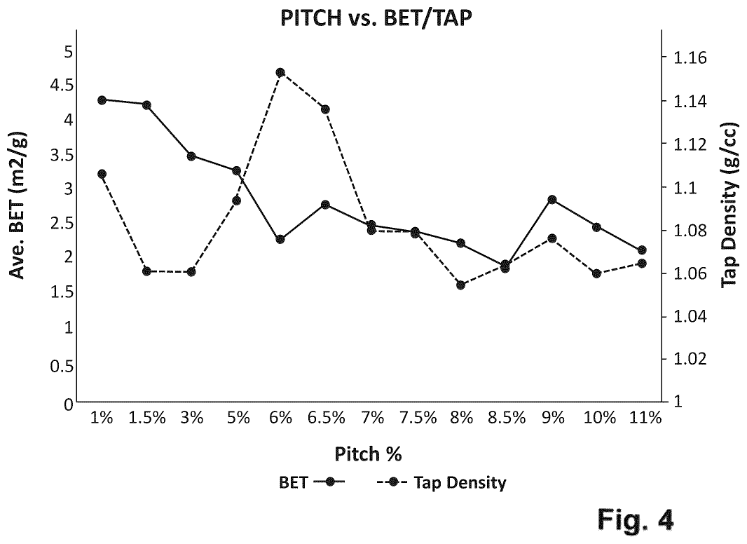

FIG. 4 shows a graph of BET and tap density as in FIG. 3. Referring to FIGS. 1-4, the graph plots BET for pitch percentage along with tap density. Optimal values for both were found at about 6-6.5 wt % pitch. Often these can be visibly recognized by a flake vs. a powder appearance. In these examples, the recycled graphite is the purified graphite recovered from the process of FIG. 1, or similar comingling and co-precipitation process.

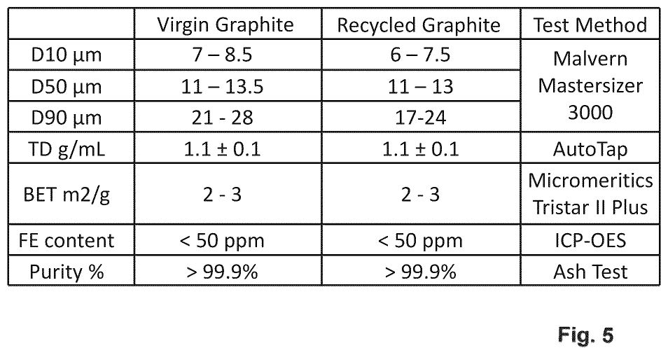

FIG. 5 shows the properties of pitch coated purified graphite resulting from the disclosed process compared to virgin/control sourced graphite. Referring to FIGS. 1-5, performance characteristics for virgin graphite and recycled graphite are shown. Recovery of anode materials complements the cathode recovery as a sequential receiver of the black mass solids remaining following the cathode leach and co-precipitation. The substantially equivalent or superior performance characteristics confirm this synergistic approach.

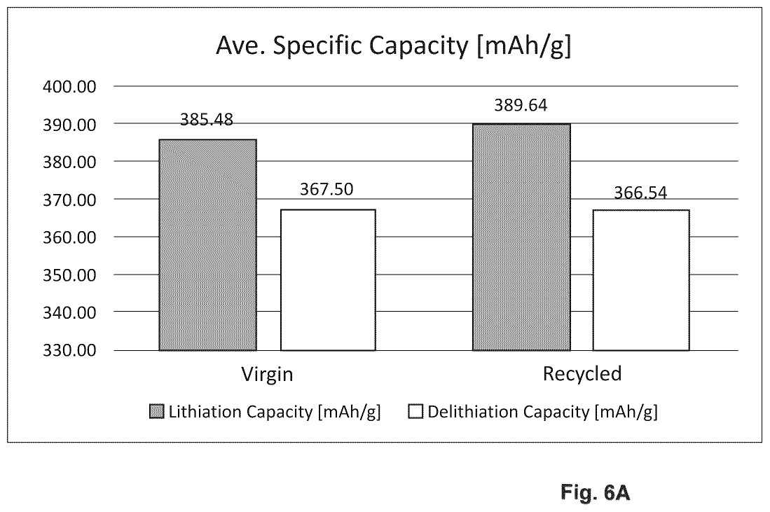

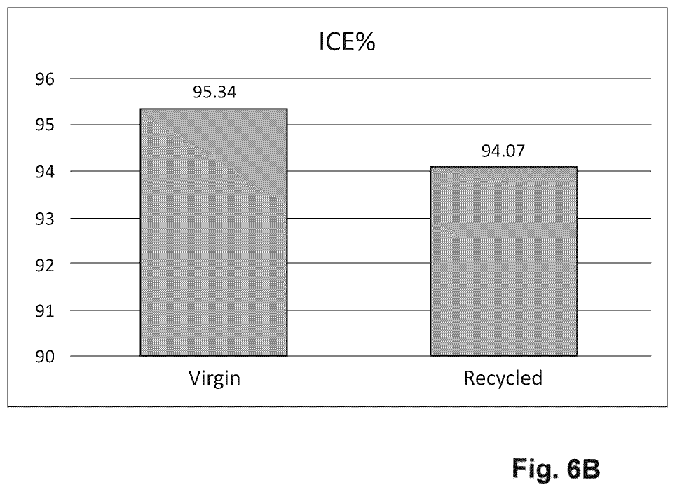

FIGS. 6A-6B show respective graphs of the specific capacity and ICE % (initial coulombic efficiency) of virgin and pitch coated purified graphite. In FIG. 6A, specific capacity is shown for virgin and coated materials, again showing equivalent or superior performance of the present coated materials. Specific capacity refers to the electrical capacity of the charge material. With the emphasis placed on vehicle range of EVs, an electrical energy storage capacity of a battery pack is a highly sought feature. The pitch coated purified graphite material shows superior performance to the virgin material for lithiation capacity. Similarly, the coated purified material shows an insignificant difference over virgin material for delithiation capacity. FIG. 6B compares ICE % for virgin and pitch coated purified graphite materials.

While the system and methods defined herein have been particularly shown and described with references to embodiments thereof, it will be understood by those skilled in the art that various changes in form and details may be made therein without departing from the scope of the invention encompassed by the appended claims. For example, while the pitch coating process described herein includes dry mixing of the graphite and pitch, wet mixing processes may also be used, such as spray coating or solvent coating. In addition, chemical vapor deposition (CVD) techniques may also be used for combining the pitch and the graphite.

What is claimed is:

1. A method of producing a pitch coated purified graphite comprising:
combining a purified graphite from a recycled battery stream and pitch to form a graphite mixture,
heating the graphite mixture to a first maximum temperature to form a coated graphite,
combining the coated graphite and additional pitch to form a coated graphite mixture, and
heating the coated graphite mixture to a second maximum temperature to form the pitch coated purified graphite.

2. The method of claim 1, wherein the purified graphite and the pitch are combined in a graphite to pitch weight ratio of from 90:10 to 99:1.

3. The method of claim 2, wherein the graphite to pitch weight ratio is from 90:10 to 95:5.

4. The method of claim 1, wherein the coated graphite and the additional pitch are combined in a graphite to pitch weight ratio of from 90:10 to 99:1.

5. The method of claim 4, wherein the graphite to pitch ratio is from 90:10 to 95:5.

6. The method of claim 1, wherein the purified graphite and the pitch are combined for a total mixing time of from 5-60 minutes.

7. The method of claim 6, wherein the total mixing time is from 20-40 minutes.

8. The method of claim 6, wherein the purified graphite and the pitch are combined by
mixing for a first mixing time of from 5-30 minutes to form an intermediate graphite mixture,
allowing the intermediate graphite mixture to cool, and
mixing the cooled intermediate graphite mixture for a second mixing time of from 5-30 minutes to form the graphite mixture.

9. The method of claim 1, wherein the first maximum temperature is 300° C.-500° C.

10. The method of claim 1, wherein the graphite mixture is heated to the first maximum temperature at a rate of from 1-5° C./min.

11. The method of claim 1, wherein the graphite mixture is heated at the first maximum temperature for 0.5-4 hours.

12. The method of claim 1, wherein the coated graphite and the additional pitch are combined for a total mixing time of from 5-60 minutes.

13. The method of claim 12, wherein the total mixing time is from 20-40 minutes.

14. The method of claim 12, wherein the additional pitch and the coated graphite are combined by
mixing for a first mixing time of from 5-30 minutes to form an intermediate coated graphite mixture,
allowing the intermediate coated graphite mixture to cool, and
mixing the cooled intermediate coated graphite mixture for a second mixing time of from 5-30 minutes to form the graphite mixture.

15. The method of claim 1, wherein the second maximum temperature is greater than the first maximum temperature.

16. The method of claim 1, wherein the second maximum temperature is 1000° C.-1300° C.

17. The method of claim 1, wherein the graphite mixture is heated to the second maximum temperature in stages over a heating time of from 10-40 hours.

18. The method of claim 1, wherein the purified graphite is prepared by a method comprising:
leaching a black mass of exhausted lithium-ion batteries from the recycled battery stream to obtain a leach solution and a precipitate comprising graphite;
sintering the precipitate by
preparing a slurry of the precipitate with a first aqueous solution of a hydroxide base having a concentration of hydroxide of ≤40% by weight and
roasting the slurry of the precipitate at a temperature of <250° C. to form a sintered precipitate;
sintering the sintered precipitate by
preparing a slurry of the sintered precipitate with a second aqueous solution of a hydroxide base having a concentration of hydroxide of ≤40% by weight, and
roasting the slurry of the sintered precipitate at a temperature of <250° C. to form a sintered graphite; and
washing the sintered graphite to form the purified graphite.

19. The method of claim 1, wherein the sintered graphite is washed with an aqueous wash solution to a pH of from 6 to 10.

20. The method of claim 1, wherein the purified graphite has a purity of greater than 99.5%.
